(19) United States
(12) Patent Application Publication
(10) Pub. No.: US 2026/0112766 A1
(43) Pub. Date: Apr. 23, 2026

(54) BATTERY PACK

(71) Applicants: Hyundai Motor Company, Seoul (KR); Kia Corporation, Seoul (KR)

(72) Inventors: Hyun Chang Kang, Hwaseong (KR); In Gook Son, Hwaseong (KR); Gyeong Hwan Gong, Hwaseong (KR); Yu Ri Oh, Hwaseong (KR); Jun Young Kang, Hwaseong (KR)

(21) Appl. No.: 19/348,579

(22) Filed: Oct. 2, 2025

(30) Foreign Application Priority Data
Oct. 18, 2024 (KR) 10-2024-0142958
May 20, 2025 (KR) 10-2025-0065505

(51) Int. Cl. H01M 50/367; H01M 10/658; H01M 50/204; H01M 50/271; H01M 50/291

(52) U.S. Cl. CPC H01M 50/367; H01M 10/658; H01M 50/271; H01M 50/291; H01M 50/204

(57) ABSTRACT

Disclosed is a battery pack. The battery pack includes a plurality of battery modules each including a plurality of battery cells that are arranged in width direction, a pack cover covering the battery modules, and a blocking member that is supported by the pack cover, and including parts that extend from the pack cover between the battery modules. The blocking member includes a base area that is attached to the pack cover, a support area that protrudes from the base area between the plurality of battery modules, and a partition area that protrudes from the support areas toward the battery modules and extend toward space between the plurality of battery cells.

### CROSS-REFERENCE TO RELATED APPLICATION

This application claims, under 35 U.S.C. § 119(a), the benefit of Korean Patent Application No. 10-2024-0142958, filed Oct. 18, 2024, in the Korean Intellectual Property Office, and Korean Patent Application No. 10-2025-0065505, filed May 20, 2025, in the Korean Intellectual Property Office, the entire contents of which are incorporated herein by reference.

### BACKGROUND

### (a) Technical Field

The present disclosure relates to a battery pack and to battery pack configurations.

### (b) Description of the Related Art

As the demand for electric vehicles continues to increase, the demand for batteries mounted on electric vehicles is also increasing. Depending on the materials of the cathode and anode that constitute the battery, the battery may be classified into various types. Among them, a lithium ion battery is widely used because it has high energy efficiency per unit volume and a lightweight structure. However, lithium-ion batteries pose a high risk of fire and explosion due to the strong reactivity of lithium.

As an example, when a fire occurs in some of a plurality of battery cells mounted in a battery module or battery pack, a heat transfer may occur in the other battery cells due to a chain reaction when the thermal energy or gas generated by the fire is introduced into other adjacent battery cells.

### SUMMARY

The present disclosure has been made to solve the above-mentioned problems occurring in the prior art while advantages achieved by the prior art are maintained intact.

An aspect of the present disclosure provides a battery pack that may delay a heat transfer from occurring in adjacent battery cells even when a fire occurs in a battery cell.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a battery pack may include a plurality of battery modules each including a plurality of battery cells that are arranged in a width direction, a pack cover covering the battery modules, and a blocking member that is supported by the pack cover, and including parts that extend from the pack cover between the battery modules, and the blocking member may include a base area that is attached to the pack cover, a support area that protrudes from the base area between the plurality of battery modules, and a partition area that protrudes from the support areas toward the battery modules and extend toward space between the plurality of battery cells.

A plurality of partition areas may be provided and the plurality of partition areas may be configured to be spaced apart from each other in the width direction.

Each of the battery modules may include a cover member disposed between the battery cells and the pack cover and covering the battery cells, and a venting member attached onto an area of the cover member, which faces the blocking member.

The cover member may include a cover area that is disposed parallel to the battery cells, and is disposed between the battery cells and the pack cover, and a venting support area that protrudes from the cover area toward space between the battery cells, and the venting member may be attached to the cover area or the venting support area.

A width of the support area in an height direction may be greater than a width of the venting member in the height direction.

A plurality of venting members may be provided, and a number of the plurality of venting members may correspond to a number of the battery cells.

A spacing distance between the plurality of partition areas may correspond to a width of the venting members in the width direction.

The battery pack may further include a cross member that is disposed between the plurality of battery modules, and that face the blocking member, and the cross member may include a cross hole that is provided between the plurality of partition areas and is formed on an area facing the blocking member.

The cross member may include a cross member frame that defines the cross hole, and the cross member frame may define an accommodation space communicating with the cross hole.

The partition areas may be separately provided from the support area to be coupled to the support area or may be integrally formed with the support area.

The partition area may include a partition base area that is attached to the support area and facing the venting member, and a partition guide area that protrudes from the partition base area toward the battery module.

A length, by which the partition guide area protrudes from the partition base area, may be equal to or greater than half of a spacing distance between the support area and the venting member.

The partition guide area may include a first partition guide area that protrudes from a first end of the partition base area in the width direction, and a second partition guide area that protrudes from a second end of the partition base area in the width direction.

A spacing distance between the first partition guide area and the second partition guide area may correspond to a width of the venting member in the width direction.

The partition guide area may be bent from the partition base area.

The support area may include a first end connected to the base area, and a second end facing an opposite side to the first end, the support area may include a support slit extending from the second end of the support area toward the first end of the support area and having a shape opened toward the second end, and the partition area may include a partition wall slit that is inserted into the support area through the support slit.

A length, by which the partition area protrudes from the support area, may be greater than half of a spacing distance between the support area and the venting member.

A pair of base areas may be provided and configured to be spaced apart from each other in the width direction, a pair of support areas may be configured to be connected to the pair of base areas, respectively, and the partition area may be formed to have a zigzag shape between the pair of support areas.

The blocking member may include a heat-resistant member.

According to an aspect of the present disclosure, a battery pack is provided. The battery pack may comprise a plurality of battery modules each comprising a plurality of battery cells, a pack cover configured to cover the plurality of battery modules, and a blocking member supported by the pack cover. The blocking member may comprise a base area attached to the pack cover and a support area protruding from the base area between the plurality of battery modules.

According to an exemplary embodiment, the battery pack may comprise a plurality of partition areas. The plurality of battery modules may be arranged in a width direction and the plurality of partition areas may be configured to be spaced apart from each other in the width direction.

According to an exemplary embodiment, each of the battery modules, of the plurality of battery modules, may comprise a cover member disposed between the battery cells and the pack cover and covering the battery cells and a venting member attached onto an area of the cover member, which faces the blocking member.

According to an exemplary embodiment, the cover member may comprise a cover area disposed parallel to the battery cells, and disposed between the battery cells and the pack cover and a venting support area protruding from the cover area toward space between the battery cells. The venting member may be attached to the cover area or the venting support area.

According to an exemplary embodiment, a width of the support area in a height direction may be greater than a width of the venting member in the height direction.

According to an exemplary embodiment, the battery pack may comprise a plurality of venting members. A number of the plurality of venting members may correspond to a number of the plurality of battery cells.

According to an exemplary embodiment, the plurality of battery modules may be arranged in a width direction, and a spacing distance between the plurality of partition areas may correspond to a width of the venting members in the width direction.

According to an exemplary embodiment, the battery pack may comprise a cross member disposed between the plurality of battery modules, and configured to face the blocking member. The blocking member may comprise parts extending from the pack cover between the battery modules, and the cross member may comprise a cross hole provided between the plurality of partition areas and formed on an area facing the blocking member.

According to an exemplary embodiment, the cross member may comprise a cross member frame defining the cross hole, and the cross member frame may define an accommodation space communicating with the cross hole.

According to an exemplary embodiment, the blocking member may comprise a partition area protruding from the support areas toward the battery module and extending toward space between the plurality of battery cells, and the partition area may be separately provided from the support area to be coupled to the support area or is integrally formed with the support area.

According to an exemplary embodiment, the blocking member may comprise a partition area protruding from the support areas toward the battery module and extending toward space between the plurality of battery cells, and the partition area may comprise a partition base area attached to the support area and facing the venting member and a partition guide area protruding from the partition base area toward the battery module.

According to an exemplary embodiment, a length, by which the partition guide area protrudes from the partition base area, may be equal to or greater than half of a spacing distance between the support area and the venting member.

According to an exemplary embodiment, the plurality of battery modules may be arranged in a width direction, and the partition guide area may comprise a first partition guide area protruding from a first end of the partition base area in the width direction and a second partition guide area protruding from a second end of the partition base area in the width direction.

According to an exemplary embodiment, a spacing distance between the first partition guide area and the second partition guide area may correspond to a width of the venting member in the width direction.

According to an exemplary embodiment, the partition guide area may be bent from the partition base area.

According to an exemplary embodiment, the support area may comprise a first end connected to the base area and a second end facing an opposite side to the first end. The blocking member may comprise a partition area protruding from the support areas toward the battery module and extending toward space between the plurality of battery cells, the support area may comprise a support slit extending from the second end of the support area toward the first end of the support area and having a shape opened toward the second end, and the partition area may comprise a partition wall slit inserted into the support area through the support slit.

According to an exemplary embodiment, a length, by which the partition area protrudes from the support area, may be greater than half of a spacing distance between the support area and the venting member.

According to an exemplary embodiment, the battery pack may comprise a pair of base areas configured to be spaced apart from each other in a width direction. The plurality of battery modules may be arranged in the width direction.

According to an exemplary embodiment, the battery pack may comprise a pair of support areas configured to be connected to the pair of base areas, respectively. The blocking member may comprise a partition area protruding from the support areas toward the battery module and extending toward space between the plurality of battery cells, and the partition area may be formed to have a zigzag shape between the pair of support areas.

According to an exemplary embodiment, the blocking member may comprise a heat-resistant member.

According to an aspect of the present disclosure, a battery pack is provided. The battery pack may comprise a pack cover configured to cover a plurality of battery modules, each battery module comprising a plurality of battery cells, and a blocking member supported by the pack cover. The blocking member may comprise a base area attached to the pack cover and a support area protruding from the base area between the plurality of battery modules.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 illustrates a perspective view illustrating a battery module, a base plate, a cross member, and a blocking member, according to an exemplary embodiment of the present disclosure.

FIG. 2 illustrates a perspective view illustrating a battery module, according to an exemplary embodiment of the present disclosure.

FIG. 3 illustrates a plan view illustrating a venting member, according to an exemplary embodiment of the present disclosure.

FIG. 4 illustrates a vertical cross-sectional view illustrating a battery pack, according to an exemplary embodiment of the present disclosure.

FIG. 5 illustrates a perspective view illustrating a battery module, a base plate, a cross member, and a blocking member, according to an exemplary embodiment of the present disclosure.

FIG. 6 illustrates a side view illustrating a battery module, a cross member, and a blocking member, according to an exemplary embodiment of the present disclosure.

FIG. 7 illustrates a perspective view of a blocking member, according to an exemplary embodiment of the present disclosure.

FIG. 8 illustrates a plan view of a battery module and a blocking member, according to an exemplary embodiment of the present disclosure.

FIG. 9 illustrates a horizontal cross-sectional view of one pair of adjacent battery modules, and a blocking member disposed between the one pair of adjacent battery modules, according to an exemplary embodiment of the present disclosure.

FIG. 10 illustrates a horizontal cross-sectional view of a blocking member provided on one side of a battery module, according to an exemplary embodiment of the present disclosure.

FIG. 11 illustrates a perspective view of a blocking member, according to an exemplary embodiment of the present disclosure.

FIG. 12 illustrates a plan view of a battery module and a blocking member, according to an exemplary embodiment of the present disclosure.

FIG. 13 illustrates a perspective view of a blocking member, according to an exemplary embodiment of the present disclosure.

FIG. 14 illustrates an exploded perspective view of a partition area that is separated from a base area and a support area of a blocking member, according to an exemplary embodiment of the present disclosure.

FIG. 15 illustrates a plan view of a battery module and a blocking member, according to an exemplary embodiment of the present disclosure.

FIG. 16 illustrates a perspective view of a blocking member, according to an exemplary embodiment of the present disclosure.

FIG. 17 illustrates a plan view of a blocking member, according to an exemplary embodiment of the present disclosure.

FIG. 18 illustrates a horizontal cross-sectional view of a battery pack, according to an exemplary embodiment of the present disclosure.

### DETAILED DESCRIPTION

Hereinafter, some embodiments of the present disclosure will be described in detail with reference to the accompanying drawings. In adding reference numerals to the components of the drawings, it should be noted that the same components have the same numerals as possible even when they are illustrated on different drawings. Furthermore, in describing the embodiments of the present disclosure, detailed descriptions associated with well-known functions or configurations will be omitted if they may make subject matters of the present disclosure unnecessarily obscure.

In describing components of embodiments of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

In addition, terms such as first, second, and the like used herein may be used to describe various components, but the various components are not limited by these terms. The terms are used solely for the purpose of distinguishing one component from other components. For example, a first component may be referred to as a second component, and a second component may also be referred to as a first component, without departing from the scope of rights according to the inventive concepts of the present disclosure.

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well-known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

Hereinafter, various embodiments disclosed in the present disclosure will be described in detail with reference to the accompanying drawings, and the same or similar elements are designated by the same reference numerals regardless of the numerals in the drawings and redundant description thereof will be omitted.

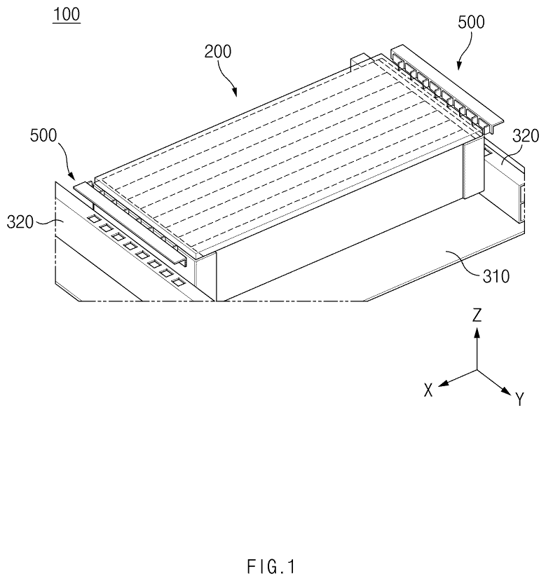

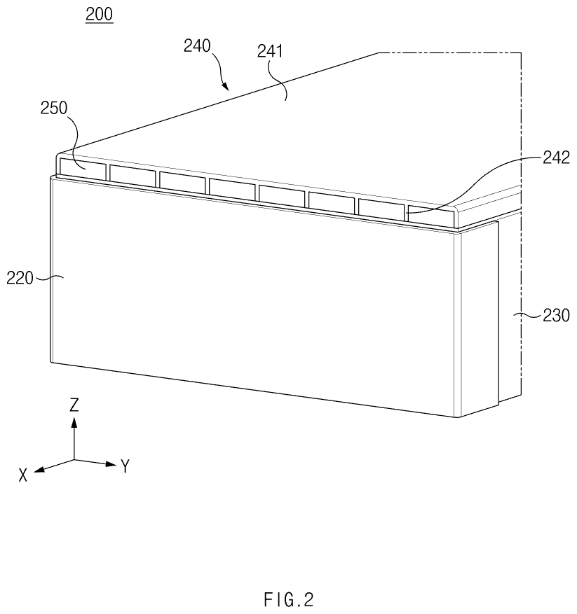

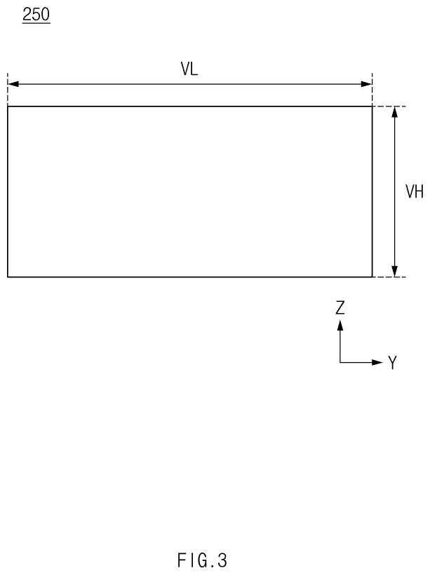

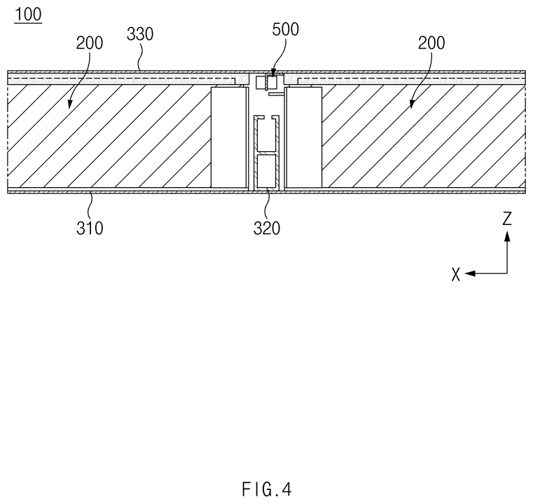

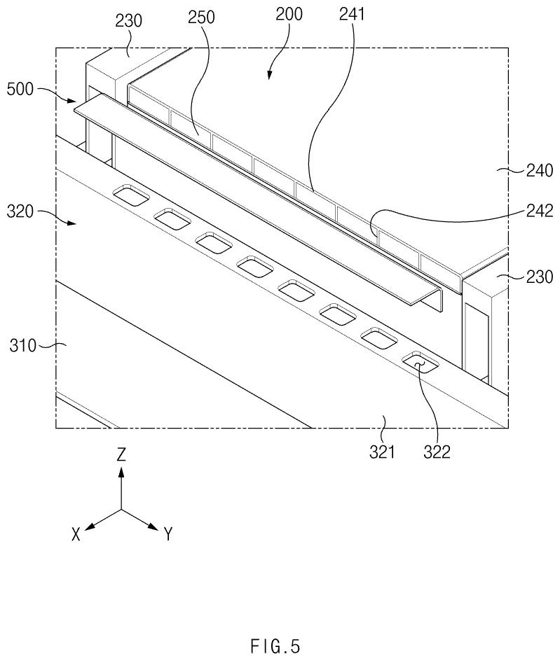

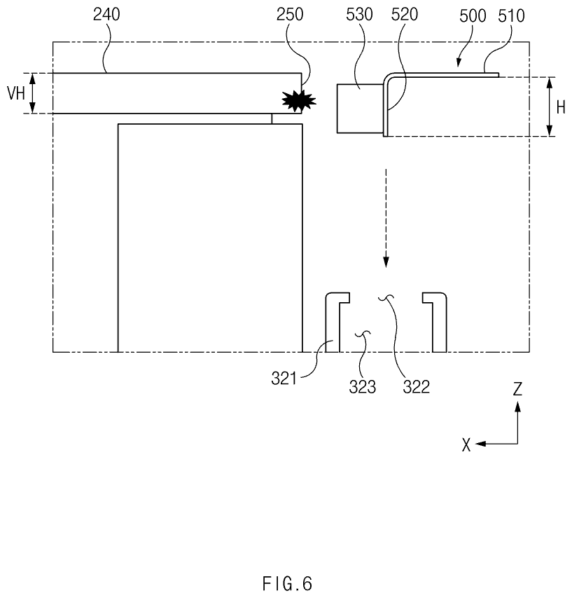

FIG. 1 is a perspective view illustrating a battery module, a base plate, a cross member, and a blocking member, according to an exemplary embodiment of the present disclosure. FIG. 2 is a perspective view illustrating a battery module, according to an exemplary embodiment of the present disclosure. FIG. 3 is a plan view illustrating a venting member, according to an exemplary embodiment of the present disclosure. FIG. 4 is a vertical cross-sectional view illustrating a battery pack, according to an exemplary embodiment of the present disclosure. FIG. 5 is a perspective view illustrating a battery module, a base plate, a cross member, and a blocking member, according to an exemplary embodiment of the present disclosure. FIG. 6 is a side view illustrating a battery module, a cross member, and a blocking member, according to an exemplary embodiment of the present disclosure.

Referring to FIGS. 1 to 6, a battery pack 100 may comprise a plurality of battery modules 200, a base plate 310 that is configured to support the battery modules 200, and a cross member 320 that is supported by the base plate 310 and is disposed between the plurality of battery modules 200.

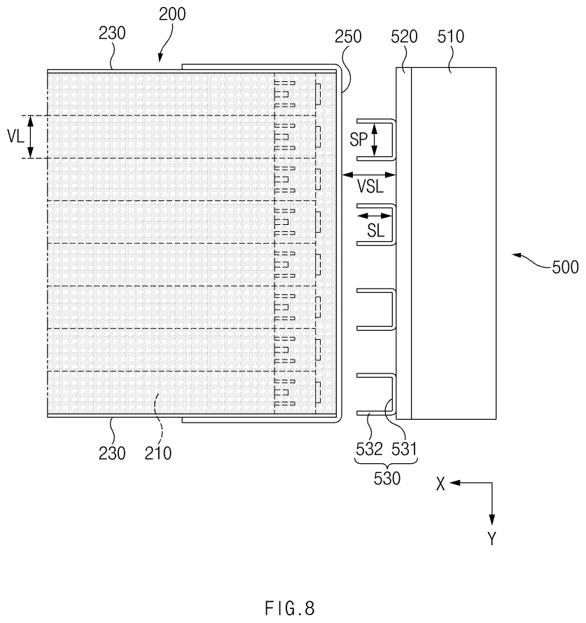

The battery module 200 may comprise a plurality of battery cells 210 (see FIG. 8) that extend in a first direction (the “X” direction or an opposite direction to the “X” direction) and are arranged in a second direction (the “Y” direction or an opposite direction to the “Y” direction) that is perpendicular to the first direction. The first direction may be referred to as a longitudinal direction and the second direction may be referred to as a width direction.

The base plate 310 may be configured to be disposed on an opposite side (an opposite to the “Z” direction) of the battery modules 200 and the cross member 320 in a third direction. The base plate 310 may be configured to support the battery modules 200 and the cross member 320. The third direction may be referred to as a height direction.

Furthermore, the battery pack 100 may further comprise a pack cover 330 that is configured to cover one area (the “Z” direction) of the battery module 200 in the third direction. The battery pack 100 may further comprise a blocking member 500 that is supported by the pack cover 330.

The pack cover 330 may be disposed in parallel to the base plate 310, and the base plate 310 and the pack cover 330 may be disposed in opposite areas (the “Z” direction or an opposite direction to the “Z”direction) of the battery modules 200 in the third direction.

The battery module 200 may comprise a sensing cover 220 that may be disposed on opposite sides (the “X” direction or an opposite direction to the “X” direction) of the plurality of battery cells 210 in the first direction, and side members 230 that are disposed on opposite sides (the “Y” direction or an opposite direction to the “Y” direction) of the plurality of battery cells 210 in the second direction, as illustrated in FIG. 2.

The battery module 200 may comprise a cover member 240 that may be disposed between the battery cells 210 and the pack cover 330 and may be configured to cover the battery cells 210, and venting members 250 that may be attached to opposite areas (the “X” direction or an opposite direction to the “X”direction) of the cover member 240 in the first direction.

The cover member 240 may comprise a cover area 241 that may be disposed in parallel to the battery cells 210 and may be disposed between the battery cells 210 and the pack cover 330, and a venting support area 242 that may be configured to protrude from the cover area 241 toward between the battery cells 210 or between the battery cells 210 and the side members 230.

A plurality of venting support areas 242 may be provided. The venting support areas 242 may be disposed and configured to be spaced apart from each other along the second direction. As an example, nine venting support areas 242 may be provided, but the present disclosure is not limited thereto.

A venting member 250 may be configured to be attached to one pair of the venting support areas 242, among the plurality of venting support areas 242, or to the cover area 241 that connects the pair of the venting support areas 242.

For example, the venting member 250 may be attached onto an area of the cover member 240, which faces the blocking member 500. In other words, the venting member 250 may be attached to the cover area 241 or the venting support area 242.

A plurality of venting members 250 may be provided. The number of the plurality of venting members 250 may correspond to the number of the battery cells 210.

The venting member 250 may be formed of a material that is likely to be damaged by an explosion pressure when a fire occurs in the battery cell 210 and an internal pressure of the battery module 200 increases.

When a fire occurs in any one of the battery cells 210, among the plurality of battery cells 210, a fluid, such as foreign substances or flames, which is caused by the fire may flow toward spaces between the battery cells 210 and the cover member 240.

Thereafter, the fluid, such as foreign substances or flames, caused by the fire may be discharged to the outside of the battery module 200 while damaging any one of the venting members 250, among the plurality of venting members 250.

For example, the venting member 250 may have a rectangular-shaped cross section. A length of the venting member 250 in the second direction (the “Y” direction or an opposite direction to the “Y” direction) may be defined as VL, and a width of the venting member 250 in the third direction (the “Z” direction or an opposite direction to the “Z” direction) may be defined as VH.

The blocking member 500 may comprise a part that extends from the pack cover 330 into a space between the battery module 200. The blocking member 500 may be configured to be attached onto one surface of the pack cover 330, which faces the cross member 320.

The blocking member 500 may be formed as a heat-resistant member, according to an exemplary embodiment.

The blocking member 500 may comprise a base area 510 that is attached to the pack cover 330, support areas 520 that protrudes from the base area 510 into spaces between the plurality of battery modules 200, and a partition area 530 that protrudes from the support area 520 toward the battery modules 200.

The base area 510 may be configured to extend parallel to the pack cover 330 between one pair of the battery modules 200.

The base area 510 and the pack cover 330 may be configured to be attached to each other by using a separate adhesive member, or one surface of the base area 510 may be formed as an attachment surface, so that the base area 510 itself functions as the adhesive member.

The support area 520 may be integrally formed with the base area 510 and may be configured to protrude from the base area 510 toward the cross member 320. The support area 520 may also be configured to protrude from the base area 510 toward the base plate 310. The support area 520 may be configured to extend parallel to one pair of the battery modules 200 between the pair of the battery modules 200.

The partition area 530 may be integrally formed with the support area 520, which may be integrally formed with the base area 510, or may be separately provided to be coupled to the support area 520.

The partition area 530 may be configured to extend in a direction that is parallel to the base area 510. A plurality of partition areas 530 may be provided to be spaced apart from each other in the second direction (the “Y” direction or an opposite direction to the “Y” direction). The plurality of partition areas 530 may be configured to extend from the support areas 520 toward spaces between the plurality of battery cells 210.

Venting spaces that face the venting members 250 may be formed between the plurality of partition areas 530. As described above, the foreign substances or fluid discharged to the outside of the battery module 200 through the venting members 250 may flow toward the venting spaces.

Cross members 320 may be provided on an opposite side (an opposite direction to the “Z” direction) in the third direction of the venting spaces. The cross members 320 may be disposed between the plurality of battery modules 200 and may be configured to face the blocking member 500.

The cross member 320 may comprise a cross member frame 321. The cross member frame 321 may define cross holes 322 that are provided between the plurality of partition areas 530 and are formed in an area that faces the blocking member 500.

A plurality of cross holes 322 may be provided. The cross holes 322 may be formed to be opened toward the blocking member 500 on one surface of the cross member frame 321. The plurality of cross holes 322 may be arranged to be spaced apart from each other along the second direction (the “Y”direction or an opposite direction to the “Y”direction).

The cross member frame 321 may be configured to define an accommodation space 323 that communicates with the cross holes 322. The accommodation space 323 may be formed on an opposite side of the blocking member 500 with respect to the cross holes 322. The accommodation space 323 may be configured to extend in a lengthwise direction of the cross member frame 321 to communicate with all of the plurality of cross holes 322.

Foreign substances or fluid(s) that flow into the venting space may be accommodated between one pair of the partition areas 530 and may be accommodated in the accommodation space 323 through the cross holes 322 that are provided on an opposite side (an opposite direction to the “Z”direction) of the partition areas 530 in the third direction.

Thereafter, the foreign substances or fluid that are introduced into the accommodation space 323 may flow in the lengthwise direction of the cross member frame 321.

With this structure, not only the fluid, such as foreign substances or flames, which may be generated from the battery cell 210, in which the fire occurred, may be prevented from transferring heat to other battery cells 210 inside the battery module 200, but also the fluid may be prevented from flowing to other battery modules 200, so that a heat transfer in an interior of the battery pack 100 may be delayed.

As illustrated in FIG. 6, a width “H” of the support area 520 in the third direction (the “Z” direction or an opposite direction to the “Z” direction) may be greater than a width VH of the venting member 250 in the third direction (the “Z” direction or an opposite direction to the “Z” direction). Here, the third direction may be an height direction.

With this structure, the fluid(s), such as foreign substances or flames, which is discharged to the outside of the battery module 200 through the venting member 250, may be blocked by the blocking member 500, so that the fluid may be prevented from flowing to other battery modules 200.

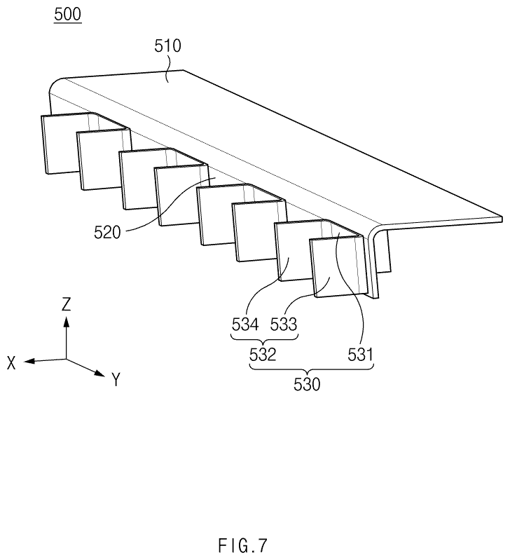

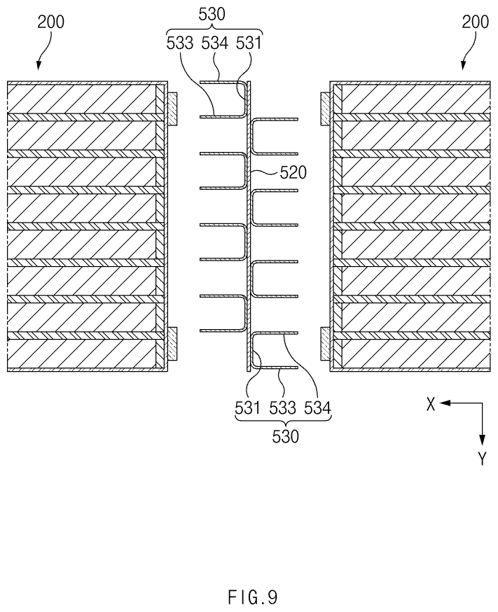

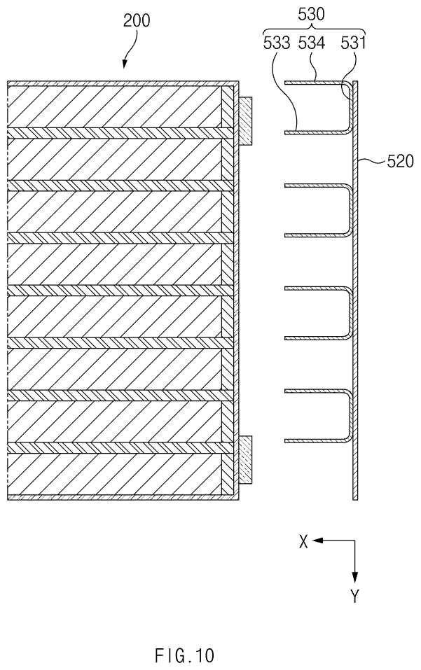

FIG. 7 illustrates a perspective view of a blocking member, according to an exemplary embodiment of the present disclosure. FIG. 8 illustrates a plan view of a battery module and a blocking member, according to an exemplary embodiment of the present disclosure. FIG. 9 illustrates a horizontal cross-sectional view of one pair of adjacent battery modules, and a blocking member disposed between the one pair of adjacent battery modules, according to an exemplary embodiment of the present disclosure. FIG. 10 illustrates a horizontal cross-sectional view of a blocking member provided on one side of a battery module, according to an exemplary embodiment of the present disclosure.

Referring to FIGS. 7 to 10, the partition area 530 of the blocking member 500, according to an exemplary embodiment of the present disclosure, may be integrally formed with the support area 520 or may be formed as a separate structure to be coupled to the support area 520.

The partition area 530, according to an exemplary embodiment of the present disclosure, may comprise a partition base area 531 that is attached to the support area 520 and faces the venting member 250, and a partition guide area 532 that protrudes from the partition base area 531 toward the battery modules 200.

The partition guide area 532 may comprise a first partition guide area 533 that protrudes from one end of the partition base area 531 in the second direction (the “Y” direction or an opposite direction to the “Y” direction), and a second partition guide area 534 that protrudes from an opposite end of the partition base area 531 in the second direction (the “Y” direction or an opposite direction to the “Y”direction).

The first partition guide area 533 and the second partition guide area 534 may be configured to extend parallel to each other. A venting space may be formed between the first partition guide area 533 and the second partition guide area 534 that are adjacent to each other.

The partition guide area 532 and the partition base area 531 may be integrally formed with each other. The partition guide area 532 may be bent from the partition base area 531. That is, the first and second partition guide areas 533 and 534 may be bent from the partition base area 531.

As illustrated in FIG. 8, a length SL, by which the partition guide area 532 protrudes from the partition base area 531 toward the battery modules 200, may be equal to or greater than half of a spacing distance VSL between the support area 520 and the venting member 250.

Furthermore, a length SL, by which the partition guide area 532 protrudes from the partition base area 531 toward the battery modules 200, may be equal to or greater than half of a spacing distance between the partition base area 531 and the venting member 250.

With this structure, even though foreign substances or fluid discharged to the outside of the battery module 200 through the venting member 250 are reflected by the partition base area 531 or the support area 520, the fluid may be more likely to be reflected by the partition area 530, rather than flowing back toward the battery modules 200.

Accordingly, with this structure, foreign substances or fluid caused by a fire that occurred in the battery module 200 may be prevented from flowing back toward the battery module 200.

Furthermore, a spacing distance SP between the first partition guide area 533 and the second partition guide area 534, which are adjacent to each other while being spaced apart in the second direction (the “Y” direction or an opposite direction to the “Y” direction), may correspond to a length VL of the venting member 250 in the second direction (the “Y” direction or an opposite direction to the “Y” direction).

However, the present disclosure is not limited thereto, and so that the spacing distance SP between the first partition guide area 533 and the second partition guide area 534, which may be adjacent to each other while being spaced apart in the second direction (the “Y” direction or an opposite direction to the “Y” direction), may be smaller than the length VL of the venting member 250 in the second direction, a greater number of the first and second partition guide areas 533 and 534 may be provided.

In contrast, so that the spacing distance SP between the first partition guide area 533 and the second partition guide area 534, which are adjacent to each other while being spaced apart in the second direction (the “Y” direction or an opposite direction to the “Y” direction), may be greater than the length VL of the venting member 250 in the second direction, a smaller number of the first and second partition guide areas 533 and 534 may be provided.

The above-described structure may be modified in design according to the explosion force of the flames that occur in the battery cell 210.

The blocking member 500, according to an exemplary embodiment of the present disclosure, as illustrated in FIG. 9, may comprise a plurality of partition areas 530 that extend in opposite directions based on the support area 520 when being disposed between one pair of battery modules 200.

The plurality of partition areas 530 may comprise a partition area 530 that protrudes toward any one of the pair of battery modules 200, and a partition area 530 that protrudes toward the other one of the pair of battery modules 200.

The partition area 530 that protrudes toward any one of the battery modules 200 and the partition area 530 that protrudes toward the other one of the battery modules 200 may be configured to be arranged alternately in the second direction (the “Y” direction or an opposite direction to the “Y” direction).

Meanwhile, the blocking member 500, according to an exemplary embodiment of the present disclosure, as illustrated in FIG. 10, may comprise partition areas 530 that protrude parallel to each other from the support areas 520 toward the battery module 200 when being disposed between the battery module 200 and the pack housing (not illustrated) that accommodates the battery module 200.

The blocking member 500, according to an exemplary embodiment of the present disclosure, may have the first and second partition guide areas 533 and 534 for one partition area 530, so that the costs of components may be reduced.

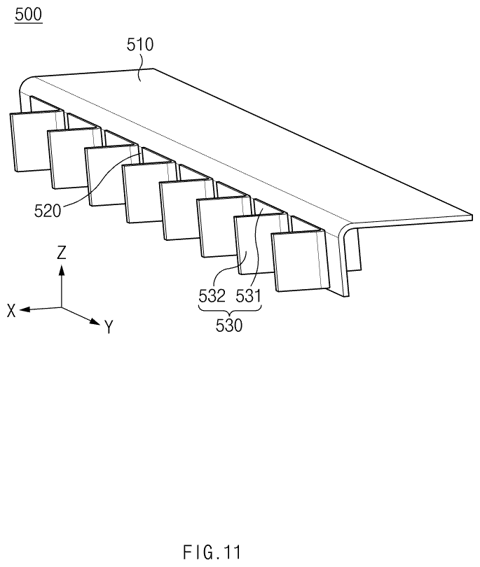

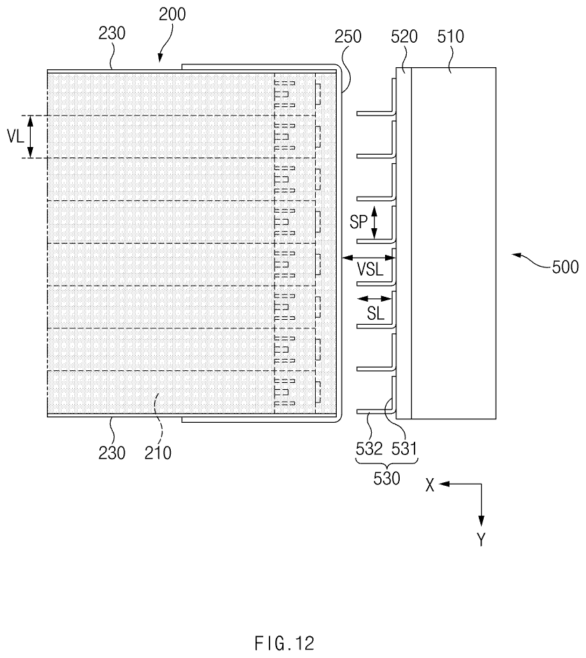

FIG. 11 illustrates a perspective view of a blocking member, according to an exemplary embodiment of the present disclosure. FIG. 12 illustrates a plan view of a battery module and a blocking member, according to an exemplary embodiment of the present disclosure.

Referring to FIGS. 11 and 12, the partition area 530 of the blocking member 500 may have an “L” shape. The partition area 530 may comprise a partition base area 531 that is attached to the support area 520 and faces the venting member 250, and a partition guide area 532 that protrudes from the partition base area 531 toward the battery modules 200.

Unlike the blocking member 500, according to an exemplary embodiment of the present disclosure, the blocking member 500, according to another embodiment of the present disclosure, may comprise only one partition guide area 532 for one partition area 530.

Accordingly, the blocking member 500, according to an exemplary embodiment of the present disclosure, may comprise eight partition areas 530, but the present disclosure is not limited thereto.

A length SL, by which the partition guide area 532 protrudes from the partition base area 531, may be equal to or greater than half of a spacing distance VSL between the partition base area 531 and the venting member 250.

Furthermore, a spacing distance SP between the plurality of partition areas 530 may correspond to a length VL of the venting member 250 in the second direction (the “Y” direction or an opposite direction to the “Y” direction).

However, the present disclosure is not limited thereto, so that the spacing distance SP between a pair of partition areas 530 that are adjacent to each other while being spaced apart in the second direction (the “Y” direction or an opposite direction to the “Y” direction) may be smaller than the length VL of the venting member 250 in the second direction, a greater number of partition areas 530 may be provided.

In contrast, so that the spacing distance SP between a pair of partition areas 530 that are adjacent to each other while being spaced apart in the second direction may be greater than the length VL of the venting member 250, a smaller number of partition areas 530 may be provided.

The above-described structure may be modified in design according to the explosion force of the flames that occur in the battery cell 210.

Because the blocking member 500, according to an exemplary embodiment of the present disclosure, may be configured to define one venting space for one blocking member 500, the rigidity of the blocking member 500 may be ensured.

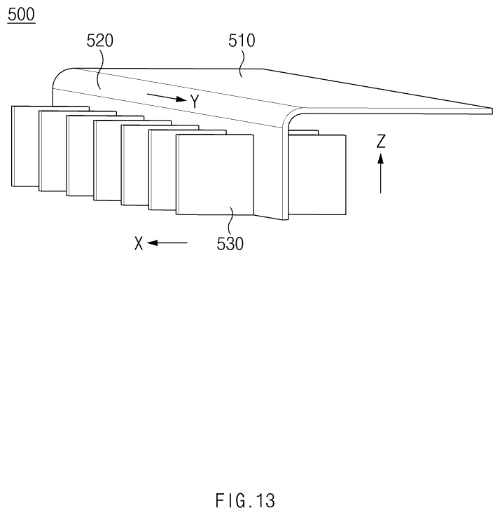

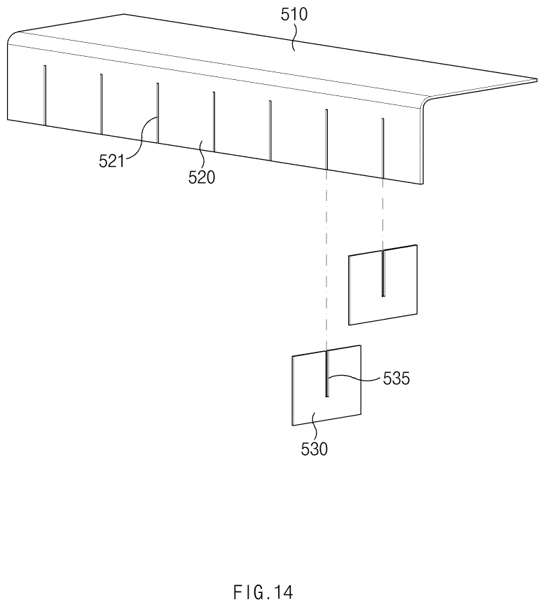

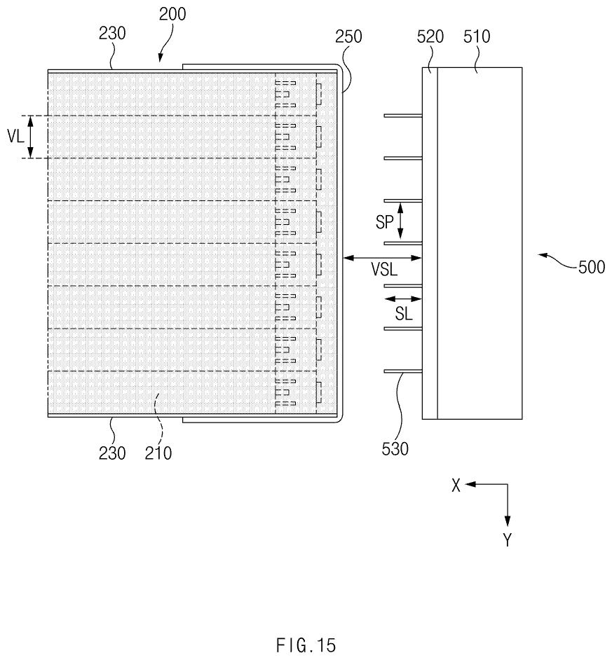

FIG. 13 illustrates a perspective view of a blocking member, according to an exemplary embodiment of the present disclosure. FIG. 14 illustrates an exploded perspective view of a partition area that is separated from a base area and a support area of a blocking member, according to an exemplary embodiment of the present disclosure. FIG. 15 illustrates a plan view of a battery module and a blocking member, according to an exemplary embodiment of the present disclosure.

Referring to FIGS. 13 to 15, the base area 510 and the support area 520 of the blocking member 500, according to an exemplary embodiment of the present disclosure may be integrally formed, and the support area 520 and the partition area 530 may be configured to be coupled to each other.

More specifically, the support area 520 may comprise one end that is connected to the base area 510 and an opposite end that faces an opposite side of the one end. The one end may comprise an end portion of the support area 520, which faces one side (the “Z” direction) in the third direction, and the opposite end may be an end portion of the support area 520, which faces the opposite side (an opposite direction to the “Z”direction) in the third direction.

The support area 520 may comprise a support slit 521 that extends from the opposite end toward the one end and is opened toward the opposite end.

The partition area 530 may comprise a partition slit 535 that is inserted into the support area 520 through the support slit 521. The partition slit 535 may be configured to extend from the one end of the partition area 530 that faces the base area 510 to an opposite side.

As the partition slit 535 is inserted through the support slit 521, the support area 520 and the partition area 530 may be coupled to each other.

Even with this structure, the length SL, by which the partition area 530 protrudes from the support area 520, may be equal to or greater than half of the spacing distance VSL between the support area 520 and the venting member 250.

Furthermore, a spacing distance SP between the partition areas 530 may correspond to a length VL of the venting member 250 in the second direction (the “Y” direction or an opposite direction to the “Y” direction).

However, the present disclosure is not limited thereto, so that the spacing distance SP between a pair of partition areas 530 that are adjacent to each other while being spaced apart in the second direction (the “Y” direction or an opposite direction to the “Y” direction) may be smaller than the length VL of the venting member 250 in the second direction, a greater number of partition areas 530 may be provided.

In contrast, so that the spacing distance SP between a pair of partition areas 530 that are adjacent to each other while being spaced apart in the second direction may be greater than the length VL of the venting member 250, a smaller number of partition areas 530 may be provided.

The above-described structure may be modified in design according to the explosion force of the flames that occur in the battery cell 210.

Because one partition area 530 of the blocking member 500, according to an exemplary embodiment of the present disclosure, may protrude toward one pair of battery modules 200, the blocking member 500 may reduce component costs compared to a structure, in which two partition areas 530 protrude from the support area 520 toward the support areas 520.

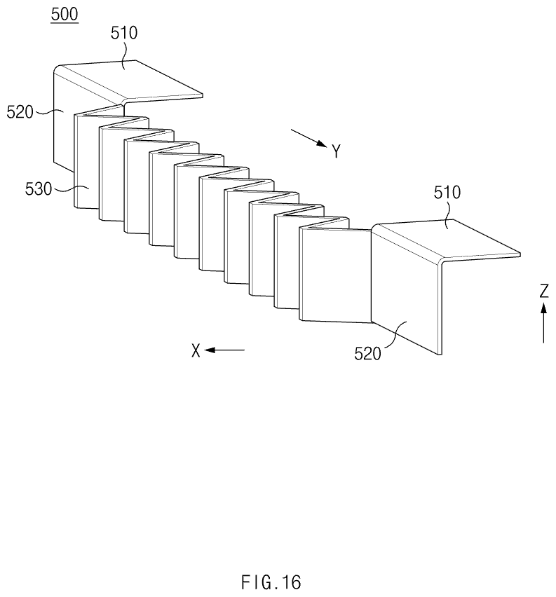

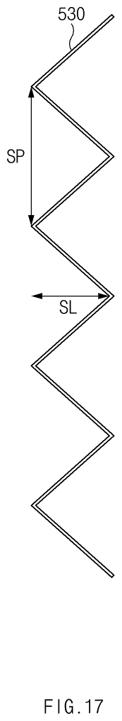

FIG. 16 illustrates a perspective view of a blocking member, according to an exemplary embodiment of the present disclosure. FIG. 17 illustrates a plan view of a blocking member, according to an exemplary embodiment of the present disclosure.

Referring to FIGS. 16 and 17, the blocking member 500 may comprise a pair of base areas 510 that are disposed on opposite sides in the second direction (the “Y” direction or an opposite direction to the “Y” direction), and a pair of support areas 520 that are connected to the pair of base areas 510, respectively.

The blocking member 500 may comprise a partition area 530 that is disposed between the pair of support areas 520 and is connected to the pair of support areas 520. The partition area 530 may comprise an integrated structure with the support areas 520, and may extend in a zigzag shape between the pair of support areas 520.

For example, a length SL in the first direction (the “X” direction or an opposite direction to the “X” direction) between one point of the partition area 530, which is closest to the battery module 200, and one point that is most distant from the battery module 200 may be equal to or greater than half of a spacing distance VSL between the point that is most distant from the battery module 200 and the venting member 250 (see FIG. 8).

Furthermore, a spacing distance SP in the second direction (the “Y” direction or an opposite direction to the “Y” direction) between two points of the partition area 530, which are closest to the battery module 200, may correspond to a length VL of the venting member 250 in the second direction the “Y” direction or an opposite direction to the “Y” direction).

However, the present disclosure is not limited thereto, and the spacing distance SP in the second direction (the “Y” direction or an opposite direction to the “Y” direction) between two points of the partition area 530, which are closest to the battery module 200, may be smaller than the length VL of the venting member 250 in the second direction in the second direction (the “Y” direction or an opposite direction to the “Y” direction).

In contrast, the spacing distance SP in the second direction (the “Y” direction or an opposite direction to the “Y” direction) between two points of the partition area 530, which are closest to the battery module 200, may be greater than the length VL of the venting member 250 in the second direction the “Y” direction or an opposite direction to the “Y” direction).

The above-described structure may be modified in design according to the explosion force of the flames that occur in the battery cell 210.

The blocking member 500, according to an exemplary embodiment of the present disclosure, may comprise an integrated structure, and may comprise a simplified structure.

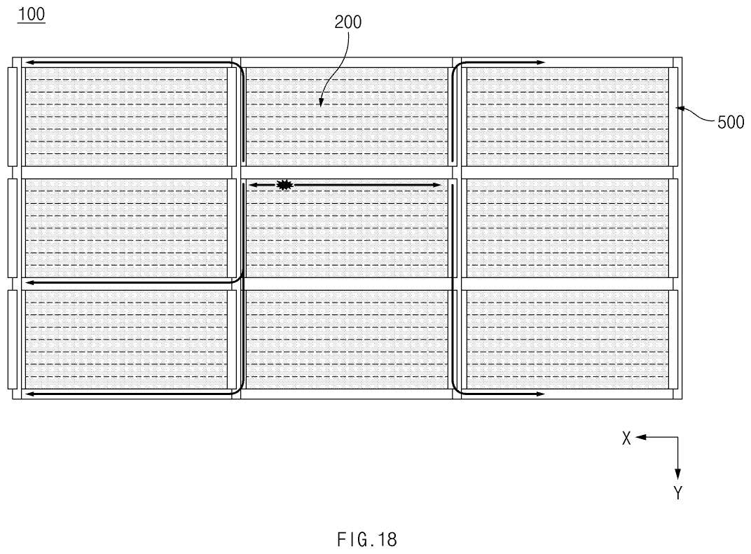

FIG. 18 illustrates a horizontal cross-sectional view of a battery pack, according to an exemplary embodiment of the present disclosure.

Referring to FIG. 18, when a fire occurs in the interior of the battery module 200, foreign substances or fluid caused by the fire may flow to the cross member 320 (see FIG. 6) through a pair of blocking members 500 that are disposed on opposite sides of the battery module 200.

Thereafter, the foreign substances or fluid may flow in the second direction (the “Y” direction or an opposite direction to the “Y” direction) through the accommodation space 323 of the cross member 320, and may be discharged to the outside of the battery pack 100 through a partition wall member provided between the pair of battery modules 200 in the second direction (the “Y” direction or an opposite direction to the “Y” direction).

As may be identified from this structure, the battery pack 100 of the present disclosure may be configured to prevent heat transfer to adjacent battery modules 200 even though a fire occurs in the interior of a battery module 200, and may delay a heat transfer in the battery pack 100.

According to the present technology, because the blocking member disposed between the battery modules may be configured to divide a space between the adjacent battery modules, it is possible to prevent thermal transfer from a battery module, in which a fire has occurred, to another adjacent battery module, so that a heat transfer may be delayed.

Furthermore, according to the present technology, because a space between the battery module and the blocking member may be divided, it is possible to prevent fluid, such as foreign substances or flames, caused by fire from being introduced back into the battery module.

Furthermore, according to the present technology, because the cross holes are provided below the venting spaces that the formed by the blocking member, and foreign substances introduced into the venting spaces may be accommodated in the accommodation space of the cross member, so that a heat transfer may be delayed.

Besides, a variety of effects directly or indirectly understood through the present disclosure may be provided.

The above description is merely an example of the technical idea of the present disclosure, and various modifications and variations may be made by one skilled in the art without departing from the essential characteristic of the present disclosure.

Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

What is claimed is:

1. A battery pack comprising:
a plurality of battery modules each comprising a plurality of battery cells;
a pack cover configured to cover the plurality of battery modules; and
a blocking member supported by the pack cover,
wherein the blocking member comprises:
a base area attached to the pack cover; and
a support area protruding from the base area between the plurality of battery modules.

2. The battery pack of claim 1, further comprising a plurality of partition areas,
wherein:
the plurality of battery modules are arranged in a width direction, and
the plurality of partition areas are configured to be spaced apart from each other in the width direction.

3. The battery pack of claim 1, wherein each of the battery modules, of the plurality of battery modules, comprises:
a cover member disposed between the battery cells and the pack cover and covering the battery cells; and
a venting member attached onto an area of the cover member, which faces the blocking member.

4. The battery pack of claim 3, wherein the cover member comprises:
a cover area disposed parallel to the battery cells, and disposed between the battery cells and the pack cover; and
a venting support area protruding from the cover area toward space between the battery cells,
wherein the venting member is attached to the cover area or the venting support area.

5. The battery pack of claim 3, wherein a width of the support area in a height direction is greater than a width of the venting member in the height direction.

6. The battery pack of claim 3, further comprising a plurality of venting members,
wherein a number of the plurality of venting members corresponds to a number of the plurality of battery cells.

7. The battery pack of claim 3, wherein:
the plurality of battery modules are arranged in a width direction, and
a spacing distance between the plurality of partition areas corresponds to a width of the venting members in the width direction.

8. The battery pack of claim 2, further comprising a cross member disposed between the plurality of battery modules, and configured to face the blocking member,
wherein:
the blocking member comprises parts extending from the pack cover between the battery modules, and
the cross member comprises a cross hole provided between the plurality of partition areas and formed on an area facing the blocking member.

9. The battery pack of claim 8, wherein:
the cross member comprises a cross member frame defining the cross hole, and
the cross member frame defines an accommodation space communicating with the cross hole.

10. The battery pack of claim 1, wherein:
the blocking member comprises a partition area protruding from the support areas toward the battery module and extending toward space between the plurality of battery cells, and
the partition area is separately provided from the support area to be coupled to the support area or is integrally formed with the support area.

11. The battery pack of claim 3, wherein:
the blocking member comprises a partition area protruding from the support areas toward the battery module and extending toward space between the plurality of battery cells, and
the partition area comprises:
a partition base area attached to the support area and facing the venting member;
and
a partition guide area protruding from the partition base area toward the battery module.

12. The battery pack of claim 11, wherein a length, by which the partition guide area protrudes from the partition base area, is equal to or greater than half of a spacing distance between the support area and the venting member.

13. The battery pack of claim 11, wherein:
the plurality of battery modules are arranged in a width direction, and
the partition guide area comprises:
a first partition guide area protruding from a first end of the partition base area in the width direction; and
a second partition guide area protruding from a second end of the partition base area in the width direction.

14. The battery pack of claim 13, wherein a spacing distance between the first partition guide area and the second partition guide area corresponds to a width of the venting member in the width direction.

15. The battery pack of claim 11, wherein the partition guide area is bent from the partition base area.

16. The battery pack of claim 3, wherein the support area comprises:
a first end connected to the base area; and
a second end facing an opposite side to the first end,
wherein:
the blocking member comprises a partition area protruding from the support areas toward the battery module and extending toward space between the plurality of battery cells,
the support area comprises a support slit extending from the second end of the support area toward the first end of the support area and having a shape opened toward the second end, and
the partition area comprises a partition wall slit inserted into the support area through the support slit.

17. The battery pack of claim 16, wherein a length, by which the partition area protrudes from the support area, is greater than half of a spacing distance between the support area and the venting member.

18. The battery pack of claim 1, further comprising:
a pair of base areas configured to be spaced apart from each other in a width direction,
wherein the plurality of battery modules are arranged in the width direction; and
a pair of support areas configured to be connected to the pair of base areas, respectively,
wherein:
the blocking member comprises a partition area protruding from the support areas toward the battery module and extending toward space between the plurality of battery cells, and
the partition area is formed to have a zigzag shape between the pair of support areas.

19. The battery pack of claim 18, wherein the blocking member comprises a heat-resistant member.

20. A battery pack comprising:
a pack cover configured to cover a plurality of battery modules, each battery module comprising a plurality of battery cells; and
a blocking member supported by the pack cover,
wherein the blocking member comprises:
a base area attached to the pack cover; and
a support area protruding from the base area between the plurality of battery modules.
